(19) United States
(12) Patent Application Publication
(10) Pub. No.: US 2012/0306915 A1
(43) Pub. Date: Dec. 6, 2012

(54) DISPLAY DEVICE, METHOD OF CONTROLLING DISPLAY DEVICE, AND RECORDING MEDIUM

(75) Inventor: Koji Takemura, Sapporo-shi (JP)

(73) Assignee: Seiko Epson Corporation, Tokyo (JP)

(21) Appl. No.: 13/483,334

(22) Filed: May 30, 2012

(30) Foreign Application Priority Data
Jun. 2, 2011 (JP) 2011-124199

(51) Int. Cl. G09G 5/377

(52) U.S. Cl. 345/629

(57) ABSTRACT

A display device adapted to display an input image includes a display section adapted to display the input image, a designation section adapted to designate a holding area in a first input image displayed by the display section, an image storage section adapted to store a whole of the first input image presently displayed in response to designation of the holding area of the first input image by the designation section, a superimposition processing unit adapted to extract the holding area designated by the designation section from the first input image stored in the image storage section, and then superimpose the extracted holding area to a second input image input after inputting the first input image to thereby generate a superimposed image, and a display control section adapted to make the display section display the superimposed image generated by the superimposition processing unit.

The entire disclosure of Japanese Patent Application No. 2011-124199 filed Jun. 2, 2011 is expressly incorporated by reference herein.

### BACKGROUND

1. Technical Field

The present invention relates to a display device for displaying an image, a method of controlling a display device, and a recording medium.

2. Related Art

In the past, there has been known a display device for performing display in a manner of dividing a display area in a plurality of regions to thereby display a plurality of images different from each other. As a typical example of this kind of device, there has been known a so-called dual-screen display for displaying a plurality of input images side by side. However, the dual-screen display is for simultaneously displaying a plurality of images simultaneously input from a plurality of input channels, and is therefore not capable of simultaneously displaying an image, which was displayed in the past, and a part of an image, which will thereafter be displayed, for example, and it is required that images are input from a plurality of input channels. Therefore, there has been proposed a device making it possible to simultaneously display a plurality of images even in the case of using a single input channel (see, e.g., JP-A-2009-75504 (Document 1)). The display device of Document 1 inhibits rewriting of a part of an image input thereto to thereby set the part to be a holding area while setting the other part to be a rewritable area to be rewritten in accordance with the input image, and is capable of simultaneously displaying a part of an image having previously been displayed and apart of an image to be displayed thereafter by forming the image data corresponding to one image using the holding area and the rewritable area.

Incidentally, in the case of simultaneously displaying a plurality of images, it is desired to enhance the freedom of display condition such as to move the part where the display is not updated, or to simultaneously display a plurality of images besides the method of holding a part of the image while rewriting the other part as in the device of Document 1. However, in the device of Document 1, since the rewriting of the holding area is inhibited, there has been a limit in enhancing the freedom.

### SUMMARY

An advantage of some aspects of the invention is to provide a display device, a method of controlling a display device, and a program each capable of making it possible to simultaneously display a part of the image having been previously displayed and a part of the image to be thereafter displayed, and thus freely controlling the display condition such as display positions with a high degree of freedom to thereby solve the problem of the related art described above.

An aspect of the invention is directed to a display device adapted to display an input image including a display section adapted to display the input image, a designation section adapted to designate a holding area in a first input image displayed by the display section, an image storage section adapted to store a whole of the first input image presently displayed in response to designation of the holding area of the first input image by the designation section, a superimposition processing unit adapted to extract the holding area designated by the designation section from the first input image stored in the image storage section, and then superimpose the extracted holding area to a second input image input after inputting the first input image to thereby generate a superimposed image, and a display control section adapted to make the display section display the superimposed image generated by the superimposition processing unit.

According to this aspect of the invention, when the holding area is designated in the first input image presently displayed, the whole of the first input image is stored, and at the same time, the holding area designated is extracted from the first input image stored, and is then superimposed to the second input image to be thereafter input to thereby be displayed, and therefore, the second input image and a part of the first input image having ever been displayed can simultaneously be displayed. Further, since the entire image is stored when the holding area is designated, it is easy to process afterward the part outside the holding area designated in the frame in the first input image stored, and it is also possible to change, for example, the holding area. Thus, the input image and the input image to thereafter be displayed can simultaneously be displayed, and the display condition such as the display position can flexibly be adjusted with a high degree of freedom.

Another aspect of the invention is directed to the display device described above, wherein the superimposition processing unit arranges the holding area extracted from the first input image stored in the image storage section at the same position where the holding area has been located when the holding area has been designated by the designation section, and then superimposes the holding area to the second input image.

According to this aspect of the invention, since the image of the area designated as the holding area is arranged at the same position as the position where the holding area has been located when the holding area has been designated, and then superimposed to the second input image to thereby be displayed, the image fitted in the intent of the user who designates the holding area can be displayed.

Still another aspect of the invention is directed to the display device described above, which further includes a holding area information storage section adapted to store holding area information representing the position of the holding area designated by the designation section for each of the first input images stored in the image storage section, and the superimposition processing unit extracts the holding area from the first input image stored in the image storage section based on the holding area information stored in the holding area information storage section.

According to this aspect of the invention, in the first input image having been displayed when the holding area has been designated, the holding area can be extracted while easily identifying the position of the holding area. Further, it is also possible to extract the area, which has not initially been designated as the holding area, as the holding area from the first input image stored by changing the holding area information, and thus, it is possible to adjust the display condition with a higher degree of freedom.

Yet another aspect of the invention is directed to the display device described above, wherein the designation section is configured to be able to instruct position change of the holding area during the display of the superimposed image by the display section, and the superimposition processing unit changes the position of the holding area in accordance with the instruction of the designation section, and then newly generates the superimposed image in response to the instruction of the position change of the holding area by the designation section.

According to this aspect of the invention, since the position of the holding area superimposed in the input image can be changed, the display condition can freely be adjusted so that, for example, the part masked by the holding area can visually be recognized.

Still yet another aspect of the invention is directed to the display device described above, wherein the image storage section is configured to be able to store a plurality of the first input images, and the superimposition processing unit respectively extracts the holding areas designated by the designation section from the plurality of the first input images stored in the image storage section, and then superimposes a plurality of the holding areas extracted to the second input image to thereby generate the superimposed image.

According to this aspect of the invention, the plurality of holding areas extracted from the plurality of first input images can be superimposed to the second input image to thereby be displayed. Further, since the entire image is stored with respect to each of the first input images, fine adjustment such as change in the holding area in each of the images becomes possible.

Further another aspect of the invention is directed to the display device described above, wherein the superimposition processing unit arranges the plurality of the holding areas extracted from the plurality of the images stored in the image storage section so as not to overlap with each other, and then superimposes the holding areas to the input image to thereby generate the superimposed image.

According to this aspect of the invention, the plurality of holding areas can be displayed while being arranged so as not to damage the visibility of each of the holding sections.

Still further another aspect of the invention is directed to a method of controlling a display device adapted to display an input image including storing a whole of a first input image presently displayed in response to designation of a holding area in the first input image presently displayed, extracting the holding area from the first input image stored in the storing, and then superimposing the extracted holding area to a second input image input after inputting the first input image to thereby generate a superimposed image, and displaying the superimposed image generated in the extracting by the display section.

By performing the control method according to this aspect of the invention, when the holding area is designated in the first input image presently displayed by the display device, the whole of the first input image is stored, and at the same time, the holding area designated is extracted from the first input image stored, and is then superimposed to the second input image to be thereafter input to thereby be displayed, and therefore, the second input image and a part of the first input image having ever been displayed can simultaneously be displayed. Further, since the whole of the first input image is stored when the holding area is designated, it is easy to process afterward the part outside the holding area designated in the frame in the first input image stored, and it is also possible to change, for example, the holding area. Thus, the input image and the input image to thereafter be displayed can simultaneously be displayed, and the display condition such as the display position can flexibly be adjusted with a high degree of freedom.

Yet further another aspect of the invention is directed to a recording medium storing a computer executable program adapted to allow a computer to control a display device adapted to display an input image, the program making the computer function as a device including a superimposition processing unit adapted to store a whole of a first input image presently displayed to an image storage section in response to designation of a holding area in the first input image presently displayed, then extract the holding area designated by a designation section from the first input image stored in the image storage section, and then superimpose the extracted holding area to a second input image input after the input of the first input image to thereby generate a superimposed image, and a display control section adapted to make the display section display the superimposed image generated by the superimposition processing unit.

By the computer executing the program recorded on the recording medium according to this aspect of the invention, when the holding area is designated in the first input image presently displayed by the display device, the whole of the first input image is stored, and at the same time, the holding area designated is extracted from the first input image stored, and is then superimposed to the second input image to be thereafter input to thereby be displayed, and therefore, the second input image and a part of the first input image having ever been displayed can simultaneously be displayed. Further, since the whole of the first input image is stored when the holding area is designated, it is easy to process afterward the part outside the holding area designated in the frame in the first input image stored, and it is also possible to change, for example, the holding area. Thus, the input image and the input image to thereafter be displayed can simultaneously be displayed, and the display condition such as the display position can flexibly be adjusted with a high degree of freedom.

According to the aspects of the invention, the input image and the input image to thereafter be displayed can simultaneously be displayed, and the display condition such as the display position can flexibly be adjusted with a high degree of freedom.

### BRIEF DESCRIPTION OF THE DRAWINGS

The invention will be described with reference to the accompanying drawings, wherein like numbers reference like elements.

FIG. 1 is a diagram showing a schematic configuration of a display system according to an embodiment of the invention.

FIG. 2 is a block diagram showing a functional configuration of the display system.

FIGS. 3A through 3C are diagrams showing an example of an operation of designating a holding area in the screen presently projected, wherein FIG. 3A shows an example of a projection image projected on the screen, FIG. 3B shows the state in which a pointer is displayed in the projection image on the screen, and the designation of the holding area has been started, and FIG. 3C shows the state in which the designation of the holding area has been completed.

FIGS. 4A through 4C are diagrams showing an example of an operation of displaying a superimposed image, wherein FIG. 4A shows a screen displayed on a monitor of a PC, FIG. 4B shows an example of an input image to be input to the projector from the PC, and FIG. 4C shows the state in which the superimposed image is projected on the screen.

FIGS. 5A and 5B are diagrams showing an example of the operation for moving the holding area in the superimposed image, wherein FIG. 5A shows the state before the movement, and FIG. 5B shows the state after the movement.

FIGS. 6A through 6C are diagrams showing an example of an operation of displaying a superimposed image by superimposing a plurality of holding areas, wherein FIG. 6A shows the state in which the holding area is designated in the projection image, FIG. 6B shows an example of an input image, and FIG. 6C shows the state in which the superimposed image having two holding areas superimposed is projected on the screen.

FIG. 7 is a flowchart showing an operation of the projector.

FIGS. 8A and 8B are diagrams showing a transition example of the screen in the case in which the holding area is changed, wherein FIG. 8A shows the state before the change, and FIG. 8B shows the state after the change.

### DESCRIPTION OF AN EXEMPLARY EMBODIMENT

Hereinafter, an embodiment of the invention will be described with reference to the accompanying drawings.

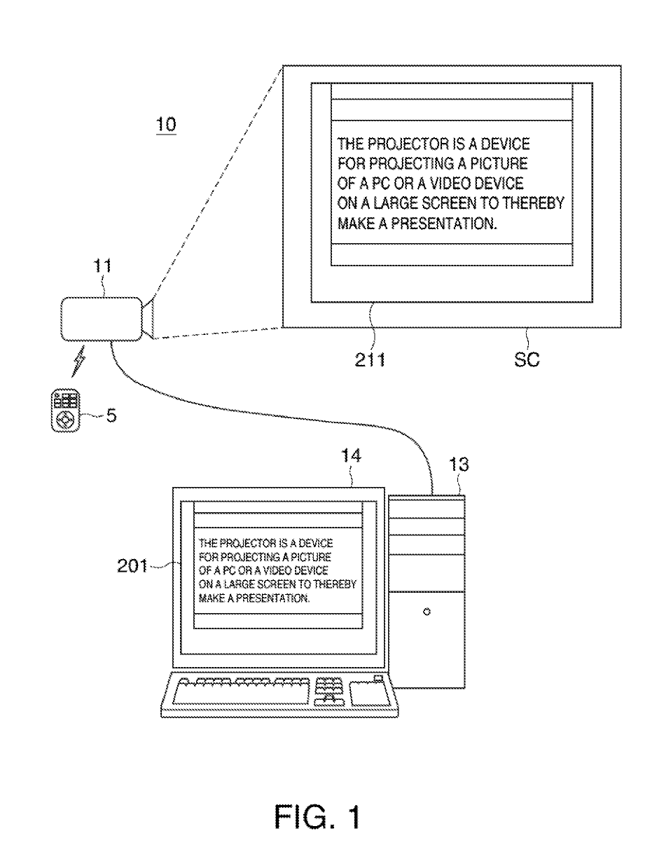

FIG. 1 is a diagram showing a schematic configuration of a display system 10 configured by connecting a projector 11 as a display device to which the invention is applied, and a personal computer (PC) 13 as an image supply device for supplying the projector 11 with an image.

The PC 13 executes an application program such as text editing software or spreadsheet software on the operating system to thereby process document data and so on. The PC 13 is provided with a monitor 14 such as a liquid crystal display, and displays a variety of images related to the running program on the monitor 14. Further, the PC 13 is connected to the projector 11 via a video signal cable and so on, and outputs the image data for displaying the image, which is the same as the image displayed on the monitor 14, to the projector 11.

It should be noted that as the image supply device for supplying the projector 11 with the input image, there can be cited a video output device such as a video playback device, a DVD playback device, a television tuner device, a set-top box of CATV, or a video game device, and so on besides the PC 13. In the present embodiment, the case of using the PC 13 will be explained as nothing more than an example.

The projector 11 projects an image on a screen SC based on the image data or the image signal input from an external image supply device such as the PC 13. In the example shown in FIG. 1, due to the control of the PC 13, a projection image 211 having the same content as that of a screen 201 displayed on the monitor 14 is projected on the screen SC. The screen 201 exemplified in FIG. 1 is a work screen of the text editing software showing the document on which the editing is performed, and the same document is also displayed on the screen SC in the same manner.

The screen SC stands roughly upright, and the screen surface is shaped like a rectangle. An image input to the projector 11 can be either of a moving image (a video) and a still image, and the projector 11 is capable of projecting the video on the screen SC and of continuously projecting the still image on the screen SC.

Further, the display system 10 is provided with a remote controller 5 as an operating device for operating the projector 11. The remote controller 5 is a device used by the user who operates the projector 11, and is capable of communicating infrared signals or a variety of wireless signals with the projector 11 to thereby provide instructions to the projector 11.

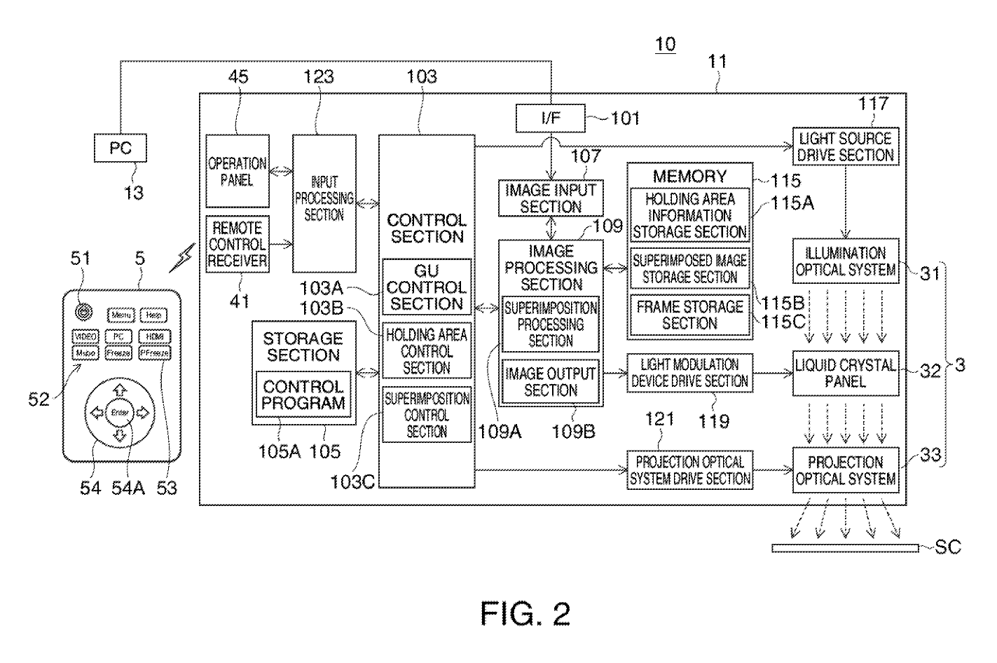

FIG. 2 is a block diagram showing a functional configuration of the display system 10.

As shown in FIG. 2, the projector 11 is provided with an interface (I/F) 101 to be connected to an external device, and the PC 13 is connected to the I/F 101. The I/F 101 is provided with, for example, an USB interface, a wired or wireless LAN interface, a VGA terminal to which an analog video signal is input, a Digital Visual Interface (DVI) to which a digital video signal is input, an S-video terminal to which a composite video signal such as NTSC, PAL, or SECAM is input, an RCA terminal to which a component video signal is input, a D-terminal to which a composite video signal is input, and an HDMI connector compliant with the HDMI (registered trademark) standard, and can further be provided with an interface circuit for inputting and outputting the signals via the terminals and connectors described above.

As shown in FIG. 2, the projector 11 is composed of a projection section 3 (a display section) for performing optical image formation, and an image processing system for electrically processing the video signal input to the projection section 3 in view of the general classification. The projection section 3 is composed of an illumination optical system 31, a liquid crystal panel 32 as a light modulation device, and a projection optical system 33. The illumination optical system 31 is provided with a light source formed of, for example, a xenon lamp, a super-high pressure mercury lamp, or a light emitting diode (LED). Further, the illumination optical system 31 can be provided with a reflector and an auxiliary reflector for guiding the light emitted by the light source to the liquid crystal panel 32, and can be a system provided with, for example, a lens group (not shown) for improving the optical characteristics of the projection light, a polarization plate, or a photochromic element for reducing the light intensity of the light emitted by the light source on the path leading to the liquid crystal panel 32.

The liquid crystal panel 32 receives the signal from the image processing system described later, and then forms the image on the panel surface. The liquid crystal panel 32 is composed of three liquid crystal panels corresponding respectively to three primary colors of RGB in order to perform color projection. Therefore, the light from the illumination optical system 31 is separated into colored lights of three colors of RGB, and the colored lights enter the corresponding liquid crystal panels, respectively. The colored lights modulated while passing through the respective liquid crystal panels are combined by a combining optical system such as a cross dichroic prism, and then output to the projection optical system 33.

The projection optical system 33 is provided with, for example, a zoom lens for performing expansion and contraction of the image to be projected and adjustment of the focus, a zoom controlling motor for controlling the level of the zoom, and a focus adjusting motor for performing the focus adjustment. The projection optical system 33 projects the incident light modulated by the liquid crystal panel 32 on the screen SC using the zoom lens and then images it.

To the projection section 3, there are connected a projection optical system drive section 121 for driving the respective motors provided to the projection optical system 33 in accordance with the control of a control section 103, and a light source drive section 117 for driving the light source provided to the illumination optical system 31 in accordance with the control of the control section 103.

The image processing system is configured including the control section 103 for integrally controlling the whole of the projector 11 as a core component, and is provided with a storage section 105 storing data to be processed by the control section 103 and a control program 105A to be executed by the control section 103, an input processing section 123 for detecting an operation via an operation panel 45 and a remote control receiver 41, an image input section 107 for processing the input video, and a light modulation device drive section 119 for driving the liquid crystal panel 32 based on the video signal output from the image input section 107 to thereby perform drawing.

The control section 103 reads out and executes the control program 105A stored in the storage section 105 to thereby control each section of the projector 11. The control section 103 detects the content of the operation performed by the user based on the operation signal input from the input processing section 123, and then controls the image input section 107, the light modulation device control section 119, the projection optical system drive section 121, and the light source drive section 117 in accordance with the operation to thereby make the projection section 3 project the video on the screen SC.

The main body of the projector 11 is provided with the operation panel 45 having various switches for the user to perform the operations, and indicator lamps. The operation panel 45 is connected to the input processing section 123, and the input processing section 123 appropriately lights or blinks the indicator lamps of the operation panel 45 in accordance with the operation state and the setting state of the projector 11 following the control of the control section 103. When the switch of the operation panel 45 is operated, the operation signal corresponding to the switch thus operated is output from the input processing section 123 to the control section 103.

Further, the projector 11 has the remote controller 5 as described above. As shown in FIG. 2, the remote controller 5 has a power switch 51 for directing to power ON/OFF the projector 11, and an operation button section 52 provided with a variety of operators for directing display of a menu screen, pause, and so on, and the operation button section 52 is provided with a button 53 for directing execution of “PFreeze,” which is a function for designating a part of the image presently displayed as the holding area, and a direction indicator key 54 as a pointing device for directing the upward, downward, rightward, and leftward directions. When the button 53 is operated, the projector 11 performs the operation of designating the holding area as described later. Further, the subsequent operation for designating the holding area can be performed using the direction indication key 54, and at the center of the direction indication key 54, there is disposed a determination key 54A for determining the operation content.

In response to the operation of the power switch 51 or each of the operators of the operation button section 52, the remote controller 5 transmits an infrared signal corresponding to the operator operated. The remote control receiver 41 provided to the main body of the projector 11 decodes the infrared signal received from the remote controller 5, then generates the operation signal representing the operation content in the remote controller 5, and then outputs it to the control section 103. It should be noted that the remote controller 5 and the remote control receiver 41 can have a configuration of communicating the operation signal using other near field communication method than the infrared signal. Further, the operation panel 45 can have a configuration provided with the operators equivalent to the remote controller 5.

To the I/F 101, there is connected the image input section 107 for obtaining the image signal or the image data input via the I/F 101, then performing determination on whether the input is an analog image signal or digital image data, identification of the data format of the digital image data, and so on, and then outputting the result to an image processing section 109 on the posterior stage as the image data.

The image input section 107 is provided with a function of performing the A/D conversion on the analog input signal to thereby output a digital signal when the analog signal is input from the external image supply device, and a function of converting the input video from the PC 13 into a video frame composed of a plurality of continuous frames compatible with the specification of the liquid crystal panel 32, and then outputting the video frame.

The image processing section 109 stores data corresponding to one frame to be projected by the projection section 3 into a memory 115 based on the image data input from the image input section 107, then generates image data for display based on the data corresponding to one frame, and then output the image data to the light modulation device drive section 119. The light modulation device drive section 119 drives the liquid crystal panel 32 based on the image data for display input from the image processing section 109 to thereby draw the image on the liquid crystal panel 32. The image drawn on the liquid crystal panel 32 is projected on the screen SC as the projection image via the projection optical system 33.

The image input to the I/F 101 from the PC 13 is input, by a function of the image input section 107, to the image processing section 109 as the image data composed of the frames at several tens of frames per second no matter the image is a still image or a moving image. The image processing section 109 develops the image data input thereto in the memory 115 frame by frame, then generates the data for displaying the image frame by frame, and then outputs the data to the light modulation device drive section 119.

Further, a superimposition processing section 109A performs the process of obtaining data of a frame from a frame storage section 115C following the control of a superimposition control section 103C described later, then extracting a designated area from the data of the frame, and then superimposing the area thus extracted to the frame of the input image to thereby combine the data of the frame corresponding to one screen.

An image output section 109B converts the input image input from the image input section 107 or the superimposed image generated by the superimposition processing section 109A into the data compatible with the display resolution and the refresh rate of the liquid crystal panel 32, and then outputs the data to the light modulation device drive section 119.

The memory 115 is a memory for temporarily developing and then storing various types of data such as the image data, and is provided with a holding area information storage section 115A, a superimposed image storage section 115B, and the frame storage section 115C in addition to the area for storing the data corresponding to one frame described above. These sections can also be those formed by imaginarily and logically separating the storage area of the memory 115, or it is also possible to actually divide the memory 115 into a plurality of areas to be assigned respectively as the holding area information storage section 115A, the superimposed image storage section 115B, and the frame storage section 115C.

Further, the projector 11 is provided with a superimposition display function of storing the input image input via the I/F 101, and then displaying a part of the image while being superimposed on the image to be input and then displayed thereafter, the processing of which is performed by the image processing section 109 under the control of the control section 103.

In the superimposition display function, an operation of designating the area (hereinafter referred to as a holding area) to be displayed in a superimposed manner is first performed on the image presently projected (displayed) on the screen SC by the projector 11. The projector 11 detects the holding area thus designated, and at the same time stores the data of the frame, which has been projected at the moment when the holding area has been designated. Then, the projector 11 generates the superimposed image by overlapping the holding image on the frame to be displayed thereafter, and then projects the superimposed image on the screen SC using the projection section 3.

Regarding the function described above, the control section 103 has a GUI (Graphical User Interface) control section 103A for realizing the operation using a GUI, a holding area control section 103B for controlling the acquisition of the holding area designated by the operation of the GUI realized by the GUI control section 103A and storage of the holding area information, and the superimposition control section 103C for controlling the process of superimposing the image in the holding area on the input image. The GUI control section 103A makes the remote controller 5 and the operation panel 45 function as designation equipment. Further, the superimposition control section 103C functions as a superimposition processing unit together with the superimposition processing section 109A, and at the same time functions as a display control section by controlling the light modulation device drive section 119 and the projection section 3.

The GUI control section 103A detects the GUI operation to the image, which the projection section 3 presently projects on the screen SC based on the data output to the light modulation device drive section 119 by the image processing section 109.

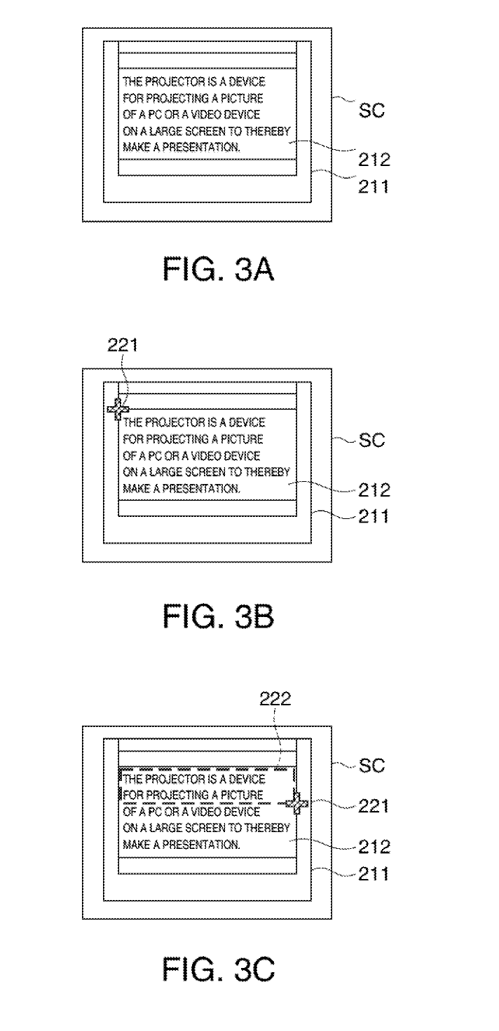

FIGS. 3A through 3C are diagrams showing an example of an operation of designating a holding area in the screen presently projected, wherein FIG. 3A shows an example of a projection image on the screen, FIG. 3B shows the state in which a pointer is displayed in the projection image on the screen, and the designation of the holding area has been started, and FIG. 3C shows the state in which the designation of the holding area has been completed.

FIG. 3A shows the state in which the projection image 211 is projected on the screen SC based on the input image input from the PC 13. The projection image 211 (a first input image) shown in FIGS. 3A through 3C is an input image input from the PC 13 for executing the text editing software similar to the case shown in FIG. 1, and the document in the editing process is displayed as an object 212.

Here, if the button 53 of the remote controller 5 is operated, the GUI control section 103A of the control section 103 realizes the GUI operation with respect to the projection image on the screen SC. Specifically, as shown in FIG. 3B, a pointer 221 is made to be projected so as to be superimposed on the projection image 211. The pointer 221 is projected (displayed) by the superimposition processing section 109A combining the image for the pointer prepared in advance with the image data for display under the control of the GUI control section 103A. The superimposition processing section 109A performs a process such as expansion/contraction of the image of the pointer 221 if necessary. The GUI control section 103A holds the positions of the object 212 and the pointer 221 constituting the projection image 211 in the projection image 211, the resolution of the projection image 211, and the positions of the object 212 and the pointer 221 on the screen SC.

The operation for designating the holding area is started from the state shown in FIG. 3B. Here, the start of the designation of the holding area is instructed by the operation of the operation button 52, and when the direction indication key 54 provided to the remote controller 5 is operated, the GUI control section 103A moves the pointer 221 in accordance with the operation of the direction indication key 54, and at the same time, an area 222 corresponding to the present position of the pointer 221 is drawn taking the start position of the movement as the reference. By moving the pointer 221 as described above, the area 222 having a rectangular shape shown in FIG. 3C is selected.

The GUI control section 103A detects the information for specifying the area 222, and the holding area control section 103B stores the information to the holding area information storage section 115A as the holding area information. The holding area information includes the information representing the resolution of the area 222, the vertical and lateral sizes (e.g., the number of pixels) thereof, the position thereof in the projection image, and so on.

Further, the holding area control section 103B stores the data of the frame of the projection image 211, which has been displayed when the area 222 has been designated, to the frame storage section 115C, and makes the data of the frame and the holding area information stored in the holding area information storage section 115A correspond to each other.

Hereinabove, there is explained the example of designating the holding area using the GUI in which the projector 11 moves the pointer 221 on the screen SC in accordance with the operation of the operation button section 52 of the remote controller 5 and the direction indication key 54 thereof. The method of designating the holding area is not limited thereto. It is also possible that, for example, the projector 11 is provided with a camera (an image shooting device), and detects the position and the size of the holding area designated by the operation of the user based on the shot image data shot by the camera.

Further, the control section 103 has the superimposition control section 103C for superimposing the holding area designated as shown in FIGS. 3A through 3C to the input image to thereby display the superimposed image.

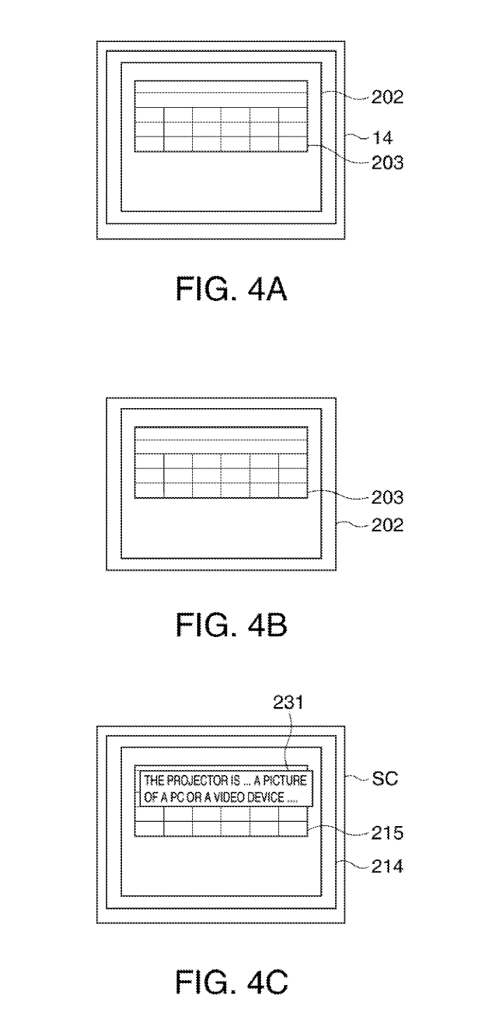

FIGS. 4A through 4C are diagrams showing an example of the operation of displaying the superimposed image, wherein FIG. 4A shows a screen displayed on the monitor 14 of the PC 13, FIG. 4B shows an example of the input image to be input to the projector from the PC 13, and FIG. 4C shows the state in which the superimposed image is projected on the screen.

If, for example, the PC 13 is switched from the state of displaying the screen of the text editing software to the operation of displaying the screen of the spreadsheet software, the image displayed on the monitor 14 is switched from the screen 201 (FIG. 1) to a screen 202 (a second input image) shown in FIG. 4A. In the screen 202, there is displayed an object 203 specific to the spreadsheet software. In this case, the screen 202 shown in FIG. 4B is input from the PC 13 to the projector 11.

Here, the superimposition control section 103C of the control section 103 controls the superimposition processing section 109A of the image processing section 109 to perform the process of superimposing the holding area designated in the procedure shown in FIGS. 3A through 3C to the screen 202. In this process, the superimposition control section 103C obtains the holding area information stored in the holding area information storage section 115A. Then, the superimposition processing section 109A obtains the data of the frame (the whole of the image) corresponding to the holding area information from the frame storage section 115C, and then extracts the image data of the holding area.

The superimposition processing section 109A obtains the frame of the input image input from the image input section 107, then combines the image data of the holding area with the frame by superimposing the image data of the holding area to the frame to thereby form the image data of one frame. The superimposition section 109A is capable of temporarily developing the superimposed image thus generated in the superimposed image storage section 115B and performing a process thereon, and the image output section 109B converts the image data developed in the superimposed image storage section 115B into the data compatible with the display resolution and the refresh rate of the liquid crystal panel 32, then outputs the data to the light modulation device drive section 119, and then makes the projection section 3 project the data on the screen SC.

In the projection image, a holding area 231 is displayed together with an object 215 included in the screen 202 as a superimposed image 214 shown in FIG. 4C. The holding area 231 is the area designated by the area 222 in FIG. 3C.

In the superimposed image 214, a part of the object 212 (FIG. 3A) related to the document having been processed by the text editing software is displayed as the holding area 231 together with the object 215 for displaying the calculation result and so on of the spreadsheet software. Therefore, a plurality of pieces of information processed in a plurality of types of software can be displayed in one screen. Further, the information included in the image having once been output by one PC 13 and the information thereafter output can simultaneously be displayed without performing switching between the input lines. Further, in the superimposed image 214, the holding area 231 is disposed at the same position as that of the holding area 231 in the projection image 211 (FIG. 3C) having been projected on the screen when the holding area 231 has been designated.

Incidentally, in the superimposed image 214 shown in FIG. 4C, the holding area 231 overlaps the object 215 to thereby mask a part of the content of the object 215. On this occasion, it is possible to move the holding area 231 by the operation of the remote controller 5.

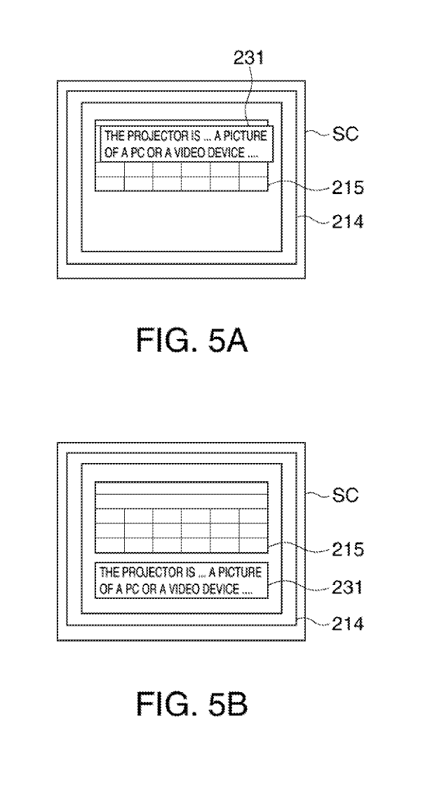

FIGS. 5A and 5B are diagrams showing an example of the operation for moving the holding area in the superimposed image, wherein FIG. 5A shows the state before the movement, and FIG. 5B shows the state after the movement. The state before the movement shown in FIG. 5A is the same state as shown in FIG. 4C. In this state, when starting the moving operation of the holding area by the operation of the operation button section 52 of the remote controller 5, the holding area 231 is moved in accordance with the subsequent operation of the direction indication key 54. During this process, the GUI control section 103A obtains the operation amount and the operation direction of the direction indication key 54, and then controls the superimposition processing section 109A based on the information thus obtained. The superimposition processing section 109A changes the position of the holding area extracted from the data of the frame in the frame storage section 115C, and then combines it with the data of the frame of the input image by superimposing it to the data of the frame of the input image to thereby generate the superimposed image data again. The image output section 109B outputs the image to the light modulation device drive section 119.

FIG. 5B shows the state in which the holding area 231 is moved in such a manner as described above. Although the content of the holding area 231 is not changed from that before the movement, the object 215 and the holding area 231 do not overlap each other after the movement, and both of the contents can clearly be viewed.

Further, the projector 11 is also capable of displaying a plurality of holding areas while being superimposed to the input image.

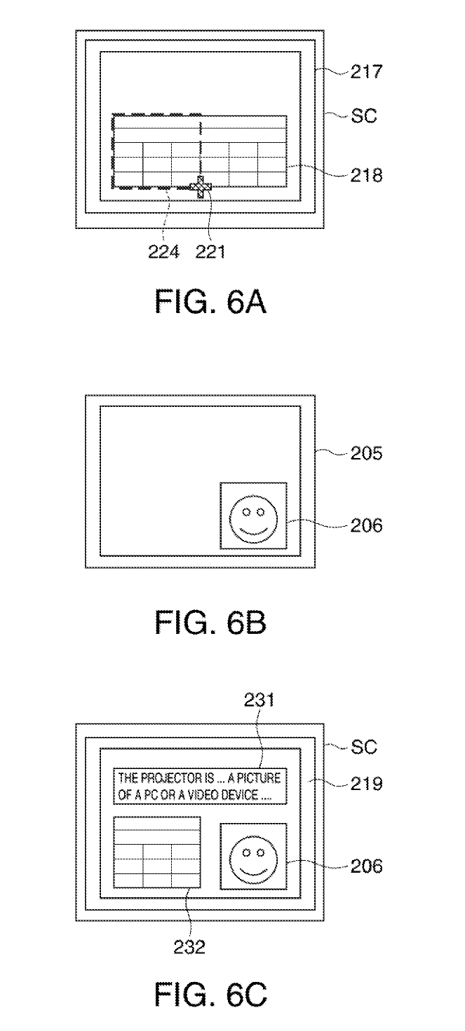

FIGS. 6A through 6C are diagrams showing an example of an operation of displaying the superimposed image by superimposing the plurality of holding areas, wherein FIG. 6A shows the state in which the holding area is designated in the projection image, FIG. 6B shows an example of the input image, and FIG. 6C shows the state in which the superimposed image having two holding areas superimposed is projected on the screen.

FIG. 6A shows how the holding area is designated by the operation of the remote controller 5 in the case in which the input image of the screen related to the execution of the spreadsheet software by the PC 13 is input similarly to the screen 202 shown in FIG. 4B. In a projection image 217 (a first input image) on the screen SC, there is displayed an object 218 related to the spreadsheet software, the pointer 221 is operated by the remote controller 5, and a part of the object 218 is designated as an area 224.

The GUI control section 103A detects the information for specifying the area 224, and the holding area control section 103B stores the information to the holding area information storage section 115A as the holding area information. Further, the holding area control section 103B stores the data of the frame of the projection image 217 having been displayed when the area 224 has been designated to the frame storage section 115C.

Subsequently, in the case in which the input image input from the PC 13 to the projector 11 is changed to a screen 205 (a second input image) including an image object 206 as shown in, for example, FIG. 6B, the superimposition control section 103C performs the process of superimposing the holding areas having ever been designated to the data of the frame of the screen 205.

The superimposition control section 103C respectively obtains the plurality of pieces of holding area information stored in the holding area information storage section 115A to thereby obtain the positions and the sizes of the holding areas, and then controls the superimposition processing section 109A. The superimposition processing section 109A obtains the data of the plurality of frames, which correspond respectively to the plurality of pieces of holding area information obtained by the superimposition control section 103C, from the frame storage section 115C, and then extracts the holding area from the data of each of the frames. Thus, the images of the plurality of holding areas are extracted. The superimposition processing section 109A combines the images of the plurality of holding areas thus extracted and the data of the frame of the screen 202 as the present input image with each other by superimposing the images to the data of the frame of the screen 202 to thereby generate the data of the superimposed image. The data of the superimposed image is output by the image output section 109B to the light modulation device drive section 119, and the projection image based on the data is projected on the screen SC by the projection section 3 as shown in FIG. 6C.

In a superimposed image 219 shown in FIG. 6C, there are displayed the holding area 231 and a holding area 232 together with the object 206 having been included in the screen 205 as the second input image. Here, the superimposition control section 103C has a function of adjusting the holding areas so as not to overlap with each other when superimposing the plurality of holding areas. Specifically, when obtaining the plurality of pieces of holding area information from the holding area information storage section 115A, the superimposition control section 103C determines presence or absence of the overlap based on the positions and the sizes of the plurality of holding areas, and then changes the display position of either of the holding areas if the overlap of the holding areas is present. In the case in which the change is made temporarily, the superimposition control section 103C does not update the holding area information. Further, in the case of holding the state in which the plurality of holding areas are adjusted so as not to overlap with each other, the superimposition control section 103C updates the holding area information stored in the holding area information storage section 115A based on the display positions after the adjustment.

The operation of the projector 11 described hereinabove will be explained with reference to a flowchart.

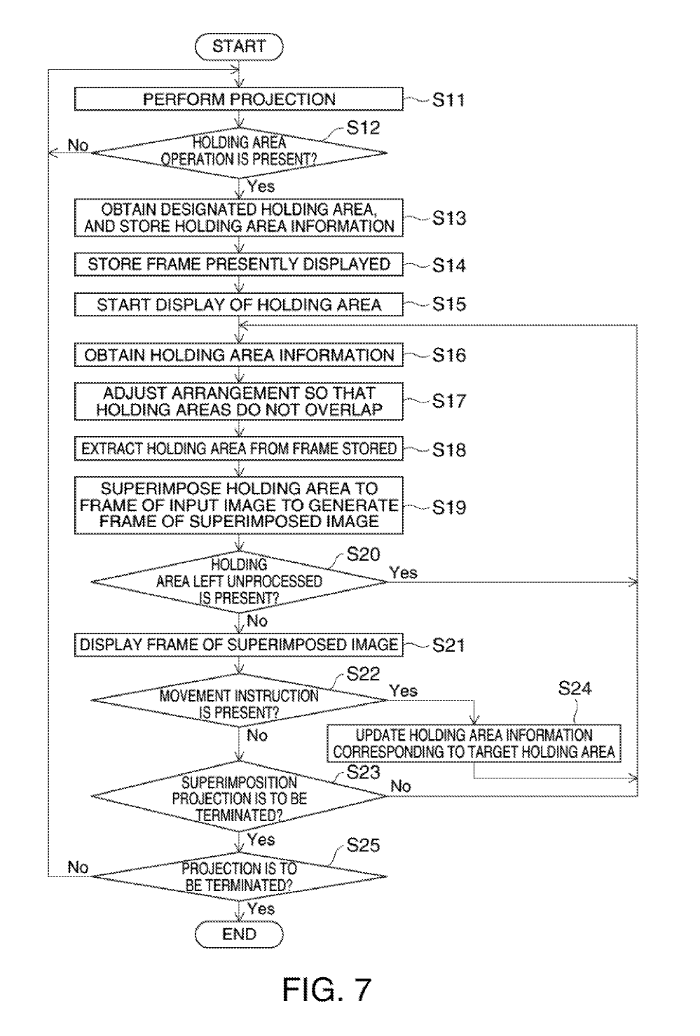

FIG. 7 is the flowchart showing the operation of the projector 11.

The control section 103 of the projector 11 starts (step S11) the projection of the image by controlling the image input section 107 and the image processing section 109 in accordance with the operation of the remote controller 5 or the operation panel 45. The control section 103 performs the ordinary projection of the image during the period in which the operation of designating the holding area using the remote controller 5 is not performed (NO in the step S12). If the operation of designating the holding area using the remote controller 5 is performed (YES in the step S12), the GUI control section 103A performs the process of the GUI necessary for the designation of the holding area in accordance with the operation of the remote controller 5 to thereby obtain the information of the holding area thus designated, and the holding area control section 103B generates the holding area information and then stores (step S13) the information into the holding area information storage section 115A.

Subsequently, the holding area control section 103B obtains the data of the frame having been displayed during the period of designating the holding area, and then stores (step S14) the data into the frame storage section 115C.

Subsequently, the control section 103 starts (step S15) the display of the holding area, and the superimposition control section 103C obtains (step S16) the holding area information from the holding area information storage section 115A. In the case in which there exists a plurality of pieces of holding area information thus obtained, the superimposition control section 103C adjusts (step S17) the arrangement of the holding areas so as not to overlap with each other. It should be noted that in the case of fixing the display positions of the respective holding areas to the state after the adjustment, the superimposition control section 103C performs the process of updating the holding area information and then storing the holding area information into the holding area information storage section 115A in the step S17.

Subsequently, under the control of the superimposition control section 103C, the superimposition processing section 109A obtains the data of the frame from the frame storage section 115C, and then extracts (step S18) the holding area from the data of each of the frames. Then, the superimposition processing section 109A superimposes the holding area to the frame of the input image to thereby combine the holding area and the frame with each other so as to form a single frame, thereby generating (step S19) the data of the superimposed image.

Here, the superimposition control section 103C determines (step S20) whether or not the holding area information left unprocessed exists in the holding area information storage section 115A, and if the holding area information left unprocessed exists (YES in the step S20), the process returns to the step S16. Further, if no holding area information left unprocessed exists (NO in the step S20), the superimposition control section 103C projects (step S21) the frame of the superimposed image generated in the step S19 on the screen SC using the projection section 3.

Subsequently, the control section 103 determines (step S22) whether or not the movement of the holding area in the superimposed image projected on the screen SC is instructed by the operation of the remote controller 5, and then determines (step S23) whether or not the projection of the superimposed image is to be terminated if the movement is not instructed (NO in the step S22). If the projection of the superimposed image is to be continued (NO in the step S23), the control section 103 returns the process to the step S16, and then performs the process of displaying the holding area by superimposing to a new input image. Here, it is preferable for the control section 103 to perform the process of superimposing the holding area in accordance with the cycle of updating the frame of the input image. That is, after starting the projection of the superimposed image, it is preferable that the holding area is superimposed to all of the frames of the input image. Therefore, the control section 103 repeatedly performs the process of the steps S16 through S21 at the same timing as, or a period shorter than, the period at which the frame of the input image is updated.

Further, if the movement of the holding area in the superimposed image projected on the screen SC is instructed by the operation of the remote controller 5 (YES in the step S22), the GUI control section 103A obtains the information of the holding area after the movement based on the operation for instructing the movement of the holding area, then the holding area control section 103B updates (step S24) the holding area information in the holding area information storage section 115A based on the information thus obtained, and then the process returns to the step S16. Thus, the superimposed image is generated based on the holding area information after the update, and then projected.

Further, if the display of the superimposed image is to be terminated (YES in the step S23), the control section 103 determines (step S25) whether or not the projection is to be terminated, and returns the process to the step S11 if the projection is not to be terminated, or ends the present process if the projection is to be terminated.

Further, it is also possible for the projector 11 to expand or contract the holding area when combining the superimposed image obtained by superimposing the holding area to the input image. Further, it is also possible to extract another area than the area, which has been designated as the holding area by the operation of the remote controller 5, from the data of the frame stored in the frame storage section 115C as the holding area. That is, if the information representing the position of the holding area in the original frame is updated by the control section 103, the area in the position different from the designated position can be extracted as the holding area. This can be achieved since the data of the whole of the original frame from which the holding area is extracted is stored in the frame storage section 115C.

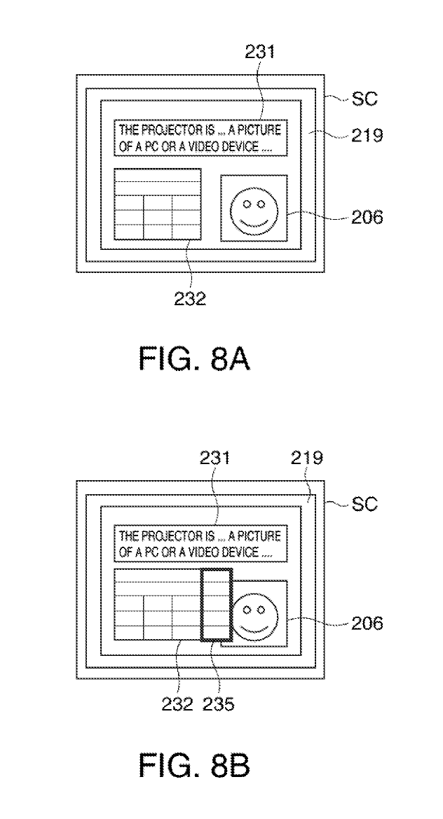

FIGS. 8A and 8B are diagrams showing a transition example of the screen in the case in which the holding area is changed, wherein FIG. 8A shows the state before the change, and FIG. 8B shows the state after the change.

The superimposed image 219 displayed on the screen SC in FIG. 8A is the same image as shown in FIG. 6C. The holding area 231 and the holding area 232 are displayed together with the object 206 having been included in the screen 205 as the input image. If the operation of expanding the holding area is performed by, for example, the remote controller 5 in the state in which the superimposed image 219 is displayed, the image projected on the screen SC is changed as shown in FIG. 8B. In the example shown in FIG. 8B, the holding area 232 is expanded rightward, and reaches the position overlapping the object 206.

In the explanation of the specific operation example, when the button 53 of the remote controller 5, for example, is held down, the control section 103 displays the pointer 221 (FIG. 3B) in response to this operation. When the direction indication key 54 is operated in this state, the GUI control section 103A moves the pointer 221 in accordance with the operation. Then, when the determination key 54A is held down in the state in which the pointer 221 is located on the holding area, the GUI control section 103A controls the image processing section 109 to move the pointer 221 to a first end point (e.g., if the holding area has a rectangular shape, an upper left corner out of the four apexes of the holding area) as one point on the outer frame of the holding area. Subsequently, the first end point (and the two sides passing through the first end point) of the holding area is moved in accordance with the operation of the direction indication key 54, and the size of the holding area is changed in conjunction therewith. During this operation, the GUI control section 103A performs the display of the apparent size of the holding area, namely the display of moving the outer frame of the holding area.

Subsequently, when the determination key 54A is operated again, the GUI control section 103A moves the pointer 221 to a second end point (e.g., the lower right corner) as one point on the outer frame of the holding area different from the first endpoint. At the same time, the holding area control section 103B generates the holding area information based on the position of the first end point of the holding area when the determination key 54A has been operated, and then updates the holding area information stored in the holding area information storage section 115A with the holding area information newly generated. When the holding area information is updated, the superimposition control section 103C retrieves the original frame from the frame storage section 115C, then processes the original frame based on the updated holding area information to thereby newly generate the superimposed image, and then display the superimposed image with the image processing section 109. Subsequently, when the direction indication key 54 of the remote controller 5 is operated in the state in which the pointer 221 is located on the second end point, the second end point (and the two sides passing through the second end point) of the holding area is moved in accordance with this operation, and the size of the holding area is changed in conjunction therewith. It should be noted that in the case in which a plurality of images overlap due to the change in the holding area, it is also possible for the superimposition control section 103C to generate the superimposed image so that one of the holding areas and another thereof or the object overlap with each other as shown in FIG. 8B.

In the example shown in FIGS. 8A and 8B, the holding area 232 is expanded by moving the right end of the holding area 232 disposed to the lower left of the superimposed image 219. In accordance with this operation, the control section 103 updates the holding area information related to the position and the size of the holding area 232, and then generates the superimposed image 219 shown in FIG. 8B based on the updated holding area information.

As described above, since the memory 115 stores the original frame from which the holding area is extracted in the frame storage section 115C even after generating the superimposed image, it is possible to generate a new superimposed image by changing the holding area after once displaying the superimposed image. Therefore, it is possible to perform the process of, for example, displaying afterward apart outside the holding area thus designated, and it is also possible to change the position and the size of the holding area as described above. Further, the operation of changing the holding area can easily be performed after the holding area is designated or displayed by making use of the remote controller 5. It should be noted that it is also possible to perform the movement of the holding area without changing the size by similar operation and process to those described above.

Further, the operation of deleting the holding area designated can also be performed easily.

When detecting an event indicating the holding down of the button 53 of the remote controller 5, the GUI control section 103A displays the pointer 221. If the position of the pointer 221 falls within the display position of either one of the holding area information stored in the holding area information storage section 115A, the control section 103 performs the elimination of the holding area corresponding to that holding area information. Here, it is possible to eliminate only the holding area information, or to eliminate the data of the frame stored in the frame storage section 115C together therewith.

As described hereinabove, since the projector 11 according to the embodiment of the invention is a projector 11 for displaying the input image, and includes the projection section 3 for displaying the input image, the frame storage section 115C for storing the entire frame of the first input image presently displayed when the holding area is designated by the operation of the remote controller 5 or the operation panel 45 with respect to the first input image displayed by the projection section 3, the superimposition processing section 109A for extracting the holding area designated by the remote controller 5 or the operation panel 45 from the first input image stored in the frame storage section 115C, and then superimposing the holding area thus extracted to the second input image input after inputting the first input image to thereby generate the superimposed image, and the control section 103 for displaying the superimposed image generated by the superimposition processing section 109A with the projection section 3, the second input image and a part of the first input image having previously been displayed can be displayed simultaneously. Further, since the entire frame of the first input image is stored when the holding area is designated, it is easy to process afterward the part outside the holding area designated in the frame, and it is also possible to change, for example, the position of the holding area and the display position of the holding area. Thus, the input image and the input image to thereafter be displayed can simultaneously be displayed, and the display condition such as the display position can flexibly be adjusted with a high degree of freedom.

Further, since the superimposition control section 103C and the superimposition processing section 109A dispose the holding area extracted from the first input image stored in the frame storage section 115C at the same position as the position where the holding area has been located when the holding area has been designated by the remote controller 5 or the operation panel 45, and then superimpose the holding area to the second input image, the image fitting in the intent of the user having designated the holding area can be displayed.

Further, since there is provided the holding area information storage section 115A for storing the holding area information representing the position of the holding area designated by the remote controller 5 or the operation panel 45 for each of the first input images stored in the frame storage section 115C, and the superimposition processing section 109A extracts the holding area from the data of the frame of the first input image stored in the frame storage section 115C based on the holding area information stored in the holding area information storage section 115A, it is possible to easily identify the position of the holding area and then extract the holding area. Further, it is also possible to extract the area, which has not initially been designated as the holding area, as the holding area from the stored image by changing the holding area information, and thus, it is possible to adjust the display condition with a higher degree of freedom.

Further, since it is possible to instruct the position change of the holding area during the display of the superimposed image by the remote controller 5 or the operation panel 45, and the position of the holding area is changed in accordance with the instruction by the remote controller 5 or the operation panel 45, and then the superimposed image is newly generated, it is possible to freely adjust the display condition so that, for example, the part masked by the holding area can visually be recognized.

Further, since the frame storage section 115C is configured so as to be able to store a plurality of first input images, and the superimposition processing section 109A extracts the holding areas designated by the remote controller 5 or the operation panel 45 respectively from the plurality of first input images stored in the frame storage section 115C, and then generates the superimposed image by superimposing the plurality of holding areas thus extracted to the second input image, it is possible to display the plurality of holding areas extracted from the plurality of images while being superimposed to the second input image. Further, since the entire frame of the plurality of first input images is stored, fine adjustment such as change in the holding area in each of the images becomes possible.

Since the superimposition processing section 109A arranges the plurality of holding areas respectively extracted from the plurality of first input images stored in the frame storage section 115C so as not to overlap with each other, and then generates the superimposed image, it is possible to display the plurality of holding areas while arranging them so as not to damage the visibility of each of the holding areas.

It should be noted that the embodiment described above does not limit the scope of the invention, and the invention can also be applied as a different aspect from the embodiment described above. For example, although the case of displaying the image input from the PC 13 connected to the projector 11 is explained as an example in the embodiment described above, it is also possible to connect a plurality of PCs 13 to the projector 11, and to apply the invention to the case of displaying the image input from other image supply devices. Further, the display device according to the invention is not limited to the projector for projecting images on the screen SC, but various display devices including a liquid crystal monitor or a liquid crystal television set for displaying images on a liquid crystal panel, a monitor device or a television receiver for displaying images on a plasma display panel (PDP), a light emitting display device such as a monitor device or the television receiver for displaying images on an organic EL display panel called an organic light-emitting diode (OLED), an organic electroluminescence (OEL), and so on can also be included in the display device according to the invention, and further, a portable display device capable of color display of the image based on the image signal input thereto is also included therein. In this case, the liquid crystal panel, the plasma display panel, and the organic EL display panel correspond to the modulation section.

For example, although in the embodiment described above the explanation is presented citing, as an example, the configuration of using the liquid crystal panel 32 composed of the three transmissive or reflective liquid crystal panels corresponding to the respective colors of RGB as the modulation section for modulating the light emitted by the light source, the invention is not limited thereto, but can be configured, for example, using a system including one liquid crystal panel and a color wheel combined with each other, a system using three digital mirror devices (DMD), a system using one digital mirror device and a color wheel combined with each other, and so on. Here, in the case of using the just one liquid crystal panel or DMD as the modulation section, the member corresponding to the combining optical system such as the cross dichroic prism is unnecessary. Further, besides the liquid crystal panel or the DMD, any configuration capable of modulating the light emitted from the light source can be adopted without problems.

Further, the configuration in which a nonvolatile memory not shown stores the control program, which is stored in the storage section 105 in the embodiment described above, and the detection result of each of the functions of the image processing section 109 can also be adopted, the configuration in which the control program and the detection result are stored in a portable recording medium can also be adopted, or the control program and the detection result can also be stored in another device to which the projector 11 is connected via a communication network in a downloadable manner. Further, each of the functional sections of the projector 11 shown in FIG. 1 is for showing the functional configuration, and the specific mounting forms are not particularly limited. In other words, it is not necessarily required to install the hardware corresponding individually to each of the functional sections, but it is obviously possible to adopt the configuration of realizing the functions of the plurality of functional sections by one processor executing the program. Further, a part of the function realized by software in the embodiment described above can also be realized by hardware, or a part of the function realized by hardware can also be realized by software. Besides the above, the specific detailed configuration of the projector 11 can arbitrarily be modified within the scope or the spirit of the invention.

What is claimed is:

1. A display device adapted to display an input image, comprising:
a display section adapted to display the input image;
a designation section adapted to designate a holding area in a first input image displayed by the display section;
an image storage section adapted to store a whole of the first input image presently displayed in response to designation of the holding area of the first input image by the designation section;
a superimposition processing unit adapted to extract the holding area designated by the designation section from the first input image stored in the image storage section, and then superimpose the extracted holding area to a second input image input after inputting the first input image to thereby generate a superimposed image; and
a display control section adapted to make the display section display the superimposed image generated by the superimposition processing unit.

2. The display device according to claim 1, wherein
the superimposition processing unit arranges the holding area extracted from the first input image stored in the image storage section at a position where the holding area has been located when the holding area has been designated by the designation section, and then superimposes the holding area to the second input image.

3. The display device according to claim 1, further comprising:
a holding area information storage section adapted to store holding area information representing the position of the holding area designated by the designation section for each of the first input images stored in the image storage section,
wherein the superimposition processing unit extracts the holding area from the first input image stored in the image storage section based on the holding area information stored in the holding area information storage section.

4. The display device according to claim 1, wherein
the designation section is configured to be able to instruct position change of the holding area during the display of the superimposed image by the display section, and
the superimposition processing unit changes the position of the holding area in accordance with the instruction of the designation section, and then newly generates the superimposed image in response to the instruction of the position change of the holding area by the designation section.

5. The display device according to claim 1, wherein
the image storage section is configured to be able to store a plurality of the first input images, and
the superimposition processing unit respectively extracts the holding areas designated by the designation section from the plurality of the first input images stored in the image storage section, and then superimposes a plurality of the holding areas extracted to the second input image to thereby generate the superimposed image.

6. The display device according to claim 5, wherein
the superimposition processing unit arranges the plurality of the holding areas extracted from the plurality of the first input images stored in the image storage section so as not to overlap with each other, and then superimposes the holding areas to the second input image to thereby generate the superimposed image.

7. A method of controlling a display device adapted to display an input image, comprising:
storing a whole of a first input image presently displayed in response to designation of a holding area in the first input image presently displayed;
extracting the holding area from the first input image stored in the storing, and then superimposing the extracted holding area to a second input image input after inputting the first input image to thereby generate a superimposed image; and
displaying the superimposed image generated in the extracting.

8. A recording medium storing a computer executable program adapted to allow a computer to control a display device adapted to display an input image, the program making the computer function as a device comprising:
a superimposition processing unit adapted to store a whole of a first input image presently displayed to an image storage section in response to designation of a holding area in the first input image presently displayed, then extract the holding area designated by a designation section from the first input image stored in the image storage section, and then superimpose the extracted holding area to a second input image input after inputting the first input image to thereby generate a superimposed image; and
a display control section adapted to make a display section display the superimposed image generated by the superimposition processing unit.
